(19) United States
(12) Patent Application Publication
(10) Pub. No.: US 2010/0129077 A1
(43) Pub. Date: May 27, 2010

(54) TECHNIQUES FOR IMPLEMENTING A DUAL ARRAY WAVEGUIDE FILTER FOR A WAVELENGTH DIVISION MULTIPLEXED PASSIVE OPTICAL NETWORK

(75) Inventors: John BAINBRIDGE, Ottawa (CA); Tom Luk, Ottawa (CA)

Correspondence Address: KED & ASSOCIATES, LLP, P.O. Box 221200, Chantilly, VA, 20153-1200, US

(73) Assignee: Nortel Networks Limited, St. Laurent (CA)

(21) Appl. No.: 12/493,747

(22) Filed: Jun. 29, 2009

Related U.S. Application Data
(60) Provisional application No. 61/117,427, filed on Nov. 24, 2008.

(51) Int. Cl. H04J 14/02

(52) U.S. Cl. 398/79

(57) ABSTRACT

Techniques for implementing a dual array waveguide filter for a wavelength division multiplexed passive optical network (WDM-PON) are disclosed. In one particular exemplary embodiment, the techniques may be realized as an apparatus for implementing a dual waveguide filter for a wavelength division multiplexed passive optical network (WDM-PON). The apparatus may include a first light source configured to output a first broadband optical signal for generating a downstream optical signal. The apparatus may also include a second light source configured to output a second broadband optical signal for generating an upstream optical signal. The apparatus may further include a dual array waveguide filter having a first optical transmission path and a second optical transmission path, wherein the first optical transmission path is configured to spectrally slice the first broadband optical signal and the second optical transmission path is configured to demultiplex the upstream optical signal.

### CROSS-REFERENCE TO RELATED APPLICATIONS

This patent application claims priority to U.S. Provisional Patent Application No. 61/117,427, filed Nov. 24, 2008, which is hereby incorporated by reference herein in its entirety.

### FIELD OF THE DISCLOSURE

The present disclosure relates generally to wavelength division multiplexed passive optical networks and, more particularly, to techniques for implementing a dual array waveguide filter for a wavelength division multiplexed passive optical network (WDM-PON).

### BACKGROUND OF THE DISCLOSURE

Over the last few decades, telecommunications carriers have been considering an inexpensive means of using optical fibers to support access to telecommunications services over a last mile of connection between residential and business customers and a central office of a telecommunications service provider. The greatest bandwidth requirement for telecommunications services for these customers is typically not greater than a couple of gigabits per second (Gbps). To support this bandwidth requirement, studies have shown that wavelength division multiplexed passive optical networks (WDM-PONs) are the access technology that has attracted the most interest and shown the greatest commercial potential.

Wavelength division multiplexed passive optical networks (WDM-PONs) provide high-speed broadband communication services using a unique wavelength assigned to each customer. Accordingly, wavelength division multiplexed passive optical networks (WDM-PONs) may protect the confidentiality of communications and easily accommodate various communication services and bandwidth capacities that may be required by customers. Also, additional customers may be easily added to wavelength division multiplexed passive optical networks (WDM-PONs) by adding a respective number of wavelengths.

In traditional wavelength division multiplexed passive optical networks (WDM-PONs), an optical line terminal (OLT) may include a plurality of transmitters for generating a plurality of downstream optical signals and a plurality of receivers for receiving a plurality of upstream optical signals from a plurality of optical network terminals (ONTs). A bidirectional multiplexer/demultiplexer may be coupled to the plurality of transmitters and the plurality of receivers. For example, the bidirectional multiplexer/demultiplexer may couple a plurality of downstream optical signals from the plurality of transmitters to the plurality of optical network terminals (ONTs). Also, the bidirectional multiplexer/demultiplexer may couple a plurality of upstream optical signals from the plurality of optical network terminals (ONTs) to the plurality of receivers. The bidirectional multiplexer/demultiplexer may accommodate the plurality of downstream optical signals and the plurality of upstream optical signals, wherein the plurality of downstream optical signals may be transmitted in a different wavelength band than the plurality of upstream optical signals.

Currently, a plurality of downstream optical signals and a plurality of upstream optical signals are transmitted and/or received via a single bidirectional multiplexer/demultiplexer. However, several drawbacks are associated with transmitting and/or receiving a plurality of downstream optical signals and a plurality of upstream optical signals via a single bidirectional multiplexer/demultiplexer. In particular, the single bidirectional multiplexer/demultiplexer may cause a plurality of transmitters and a plurality of receivers to be packaged or fabricated on a single printed circuit board (PCB). The selection of the plurality of transmitters and the plurality of receivers packaged or fabricated on the single printed circuit board may be limited by subassembly manufacturers. Also, the single printed circuit board (PCE) containing a plurality of transmitters and a plurality of receivers may be complicated due to the single bidirectional multiplexer/demultiplexer. For example, an optical band splitting filter may be included in the single printed circuit board (PCB) containing the plurality of transmitters and the plurality of receivers in order to split the plurality of downstream optical signals and the plurality of upstream optical signals transmitted to and/or received from the single bidirectional multiplexer/demultiplexer. Also, extra optical components in order to accommodate the single bidirectional multiplexer/demultiplexer may cause extra reflection loss for the plurality of downstream optical signals and the plurality of upstream optical signals. Specifically, an endface of the extra optical components may cause a discontinuity of refractive index in an optical transmission path and thus a fraction of the plurality of downstream optical signals and the plurality of upstream optical signals may be reflected backwards to cause a reflection loss. In addition, the plurality of downstream optical signals and the plurality of upstream optical signals may be transmitted and/or received via a single bidirectional multiplexer/demultiplexer, thus the plurality of downstream optical signals and the plurality of upstream optical signals may interfere with each other and cause a degradation of the optical signals.

In view of the foregoing, it may be understood that there may be significant problems and shortcomings associated with current wavelength division multiplexed passive optical network (WDM-PON) technologies using a single bidirectional multiplexer/demultiplexer.

### SUMMARY OF THE DISCLOSURE

Techniques for implementing a dual array waveguide filter for a wavelength division multiplexed passive optical network (WDM-PON) are disclosed. In one particular exemplary embodiment, the techniques may be realized as an apparatus for implementing a dual waveguide filter for a wavelength division multiplexed passive optical network (WDM-PON). The apparatus may comprise a first light source configured to output a first broadband optical signal for generating a downstream optical signal. The apparatus may also comprise a second light source configured to output a second broadband optical signal for generating an upstream optical signal. The apparatus may further comprise a dual array waveguide filter having a first optical transmission path and a second optical transmission path, wherein the first optical transmission path is configured to spectrally slice the first broadband optical signal and the second optical transmission path is configured to demultiplex the upstream optical signal.

In accordance with other aspects of this particular exemplary embodiment, the first light source may be a L-band broadband light source.

In accordance with further aspects of this particular exemplary embodiment, the L-band broadband light source may output the first broadband optical signal having a wavelength range of 1570 nm to 1620 nm.

In accordance with additional aspects of this particular exemplary embodiment, the second light source may be a C-band broadband light source.

In accordance with yet another aspect of this particular exemplary embodiment, the C-band broadband light source may output the second broadband optical signal having a wavelength range of 1520 nm to 1570 nm.

In accordance with other aspects of this particular exemplary embodiment, the apparatus may further comprise a first optical circulator configured to couple the first broadband optical signal to the first optical transmission path of the dual array waveguide filter.

In accordance with further aspects of this particular exemplary embodiment, the apparatus may further comprise a second optical circulator configured to couple the upstream optical signal to the second transmission path of the dual array waveguide filter.

In accordance with additional aspects of this particular exemplary embodiment, the apparatus may further comprise one or more downstream transmitter subassemblies each configured to receive at least a portion of the spectrally sliced first broadband optical signal directly from the dual array waveguide filter to generate at least a portion of the downstream optical signal and output the at least a portion of downstream optical signal directly to the first transmission path of the dual array waveguide filter.

In accordance with yet another aspect of this particular exemplary embodiment, the apparatus may further comprise one or more upstream receivers each configured to receive at least a portion of the demultiplexed upstream optical signal from the second transmission path of the dual array waveguide filter.

In accordance with other aspects of this particular exemplary embodiment, the one or more downstream transmitter subassemblies and the one or more upstream receivers may be packaged on disparate printed circuit boards.

In accordance with further aspects of this particular exemplary embodiment, the first transmission path of the dual array waveguide filter may comprise a first multiplexer/demultiplexer.

In accordance with additional aspects of this particular exemplary embodiment, the second transmission path of the dual array waveguide filter may comprise a second multiplexer/demultiplexer.

In accordance with yet another aspect of this particular exemplary embodiment, the apparatus may further comprise an optical band splitting filter configured to direct the downstream optical signal to a plurality of optical network terminals via a remote node and direct the upstream optical signal from the plurality of optical network terminals via the remote node.

In accordance with other aspects of this particular exemplary embodiment, the remote node may comprise an athermal array waveguide grating configured to spectrally slice the second broadband optical signal.

In accordance with further aspects of this particular exemplary embodiment, each of the plurality of optical network terminals may comprise an upstream transmitter subassembly configured to receive at least a portion of the spectrally sliced second broadband optical signal to generate at least a portion of the upstream optical signal.

In accordance with additional aspects of this particular exemplary embodiment, each of the plurality of optical network terminals may comprise a downstream optical receiver configured to receive at least a portion of the downstream optical signal.

In accordance with yet another aspect of this particular exemplary embodiment, each of the plurality of optical network terminals may comprise an optical band splitting filter configured to direct the downstream optical signal and the upstream optical signal.

In another particular exemplary embodiment, the techniques may be realized as an apparatus for implementing a dual array waveguide filter for a wavelength division multiplexed passive optical network (WDM-PON). The apparatus may comprise a L-band light source configured to output an L-band broadband optical signal for generating a downstream optical signal. The apparatus may also comprise a C-band light source configured to output a C-band broadband optical signal to a plurality of optical network terminals via a remote node for generating an upstream optical signal. The apparatus may further comprise a dual array waveguide filter having a first optical multiplexer/demultiplexer and a second optical multiplexer/demultiplexer, wherein the first optical multiplexer/demultiplexer is configured to spectrally slice the L-band broadband optical signal and the second optical multiplexer/demultiplexer is configured to demultiplex the upstream optical signal.

In accordance with other aspects of this particular exemplary embodiment, the remote node may comprise an athermal multiplexer/demultiplexer configured to spectrally slice the C-band broadband optical signal.

In accordance with further aspects of this particular exemplary embodiment, each of the plurality of optical network terminals may comprise an upstream transmitter subassembly configured to receive the spectrally sliced C-band broadband optical signal via an optical band splitting filter and generate at least a portion of the upstream optical signal.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows an embodiment of a wavelength division multiplexed passive optical network (WDM-PON) in accordance with an embodiment of the present disclosure.

FIG. 2A shows an embodiment of a dual array waveguide filter for a wavelength division multiplexed passive optical network (WDM-PON) in accordance with an embodiment of the present disclosure.

FIG. 2B shows another embodiment of a dual array waveguide filter for a wavelength division multiplexed passive optical network (WDM-PON) in accordance with an embodiment of the present disclosure.

FIG. 3 shows another embodiment of a dual array waveguide filter for the wavelength division multiplexed passive optical network (WDM-PON) in accordance with an embodiment of the present disclosure.

### DETAILED DESCRIPTION OF EXEMPLARY EMBODIMENTS

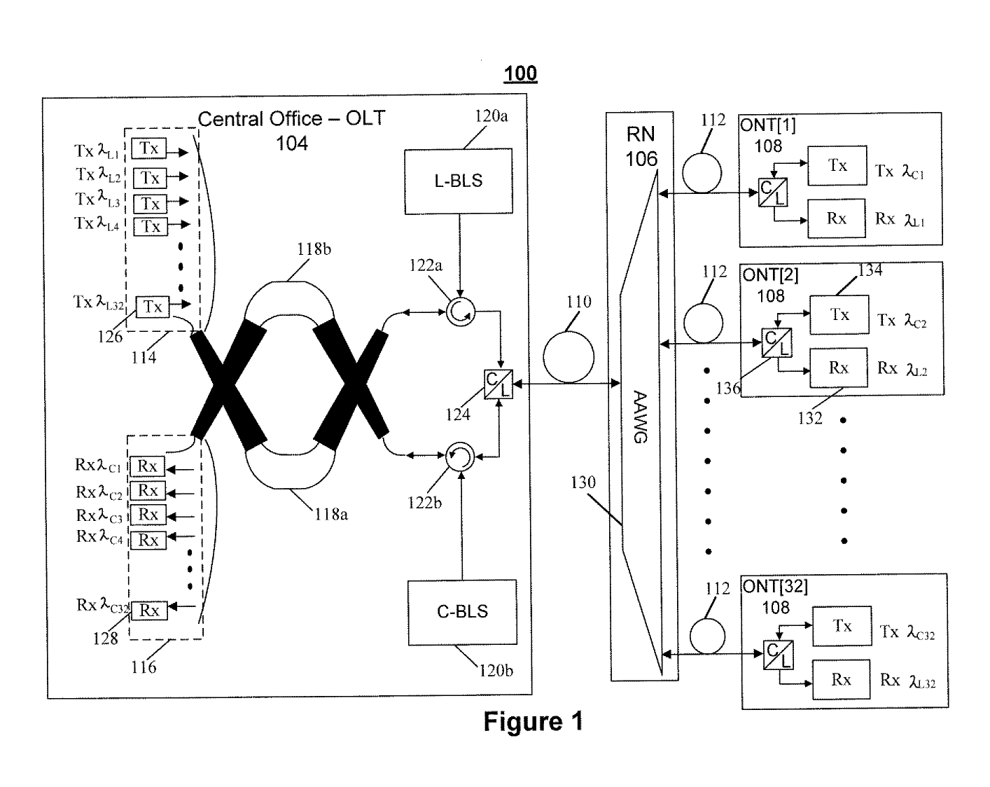

Referring to FIG. 1, there is shown an embodiment of a wavelength division multiplexed passive optical network (WDM-PON) 100 in accordance with an embodiment of the present disclosure. That is, the wavelength division multiplexed passive optical network (WDM-PON) 100 may comprise an optical line terminal (OLT) 104 (e.g., a central office of a telecommunications service provider) coupled to a remote node (RN) 106 (e.g., a multiplexer/demultiplexer) via an optical fiber 110. The remote node (RN) 106 may be coupled to a plurality of optical network terminals (ONTs) 108 via a plurality of optical fibers 112. Each of the plurality of optical network terminals (ONTs) 108 may maintain a connection with one or more customers (not shown) for facilitating telecommunications services between these customers and a telecommunications service provider.

The optical line terminal (OLT) 104 may include one or more downstream transmitter subassemblies 114, one or more upstream receiver subassemblies 116, a dual array waveguide filter 118 (e.g., a downstream multiplexer/demultiplexer 118a and an upstream multiplexer/demultiplexer 118b) for demultiplexing a multiplexed upstream optical signal and/or multiplexing downstream optical signals from the plurality of transmitter subassemblies 114, two broadband light sources 120 (e.g., first broadband light source 120a (L-band broadband optical signal having a wavelength range of 1570 nm to 1620 nm) and second broadband light source 120b (C-band broadband optical signal having a wavelength range of 1520 nm to 1570 nm)) for outputting optical signals with different wavelengths, two optical circulators 122 (e.g., first optical circulator 122a and second optical circulator 122b) for coupling the optical signals generated by the two broadband light sources 120 to the upstream and downstream optical signals, and an optical band splitting filter 124. Each of the one or more downstream transmitter subassemblies 114 may include a plurality of downstream wavelength seeded light sources (Tx) 126 (e.g., Fabry Perot laser diodes (FPLD) or reflective semiconductor optical amplifier (RSOA)). Also, each of the one or more receiver subassemblies 116 may include a plurality of upstream optical receivers (Rx) 128 (e.g., photodiodes (PD) or avalanche photodiodes (APD)).

The remote node (RN) 106 may include a multiplexer/demultiplexer 130 for demultiplexing a multiplexed downstream optical signal from the optical line terminal (OLT) 104 and/or multiplexing upstream optical signals from the plurality of optical network terminals (ONTs) 108. It may be appreciated by one having ordinary skill in the art that the dual array waveguide filter 118 and the multiplexer/demultiplexer 130 may each be an athermal 1×N array waveguide grating (AWG) capable of simultaneously multiplexing and demultiplexing input signals.

Each of the plurality of optical network terminals (ONTS) 108 may include a downstream optical receiver (Rx) 132 (e.g., photodiodes (PD) or avalanche photodiodes (APD)) and an upstream transmitter subassembly (Tx) 134 (e.g., Fabry Perot laser diode (FP-LD) or reflective semiconductor optical amplifier (RSOA)) coupled to an optical band splitting filter 136.

In operation, the first broadband light source 120a of the optical line terminal (OLT) 104 may generate and output a broadband optical signal for downstream optical signals from the plurality of downstream wavelength-seeded light sources (Tx) 126. The broadband optical signal may be coupled to the downstream multiplexer/demultiplexer 118a via first optical circulator 122a and spectrally sliced into a plurality of channels of optical signals. Each spectrally sliced channel optical signal from the downstream multiplexer/demultiplexer 118a may be injected directly into a respective downstream wavelength-seeded light source (Tx) 126. Each downstream wavelength-seeded light source (Tx) 126 may output a downstream optical signal having the same wavelength as the spectrally sliced channel optical signal that was directly injected. Each downstream optical signal output from each downstream wavelength-seeded light source (Tx) 126 may be modulated in accordance with downstream data to be transmitted. Also, each downstream optical signal output from each respective downstream wavelength-seeded light source (Tx) 126 may be directly coupled to the downstream multiplexer/demultiplexer 118a and multiplexed by the downstream multiplexer/demultiplexer 118a. A resulting multiplexed downstream optical signal may be transmitted to the optical fiber 110 via the circulator 122a and the optical band splitting filter 124 and subsequently transmitted to the remote node (RN) 106.

The multiplexed downstream optical signal transmitted to the remote node (RN) 106 may be input to the multiplexer/demultiplexer 130 and demultiplexed. Resulting demultiplexed downstream optical signals may be transmitted to the plurality of optical network terminals (ONTs) 108 via the plurality of optical fibers 112.

The second broadband light source 120b of the optical line terminal (OLT) 104 may generate and output a broadband optical signal for upstream optical signals from the plurality of optical network terminals (ONTs) 108. The broadband optical signal generated by the second broadband light source 120b may be transmitted to the multiplexer/demultiplexer 130 of the remote node (RN) 106 via the circulator 122b and the optical fiber 110. The multiplexer/demultiplexer 130 may spectrally slice the broadband optical signal into a plurality of channels of optical signals. Each spectrally sliced channel optical signal may be transmitted to a respective optical network terminal (ANT) 108 via a respective optical fiber 112. Each spectrally sliced channel optical signal may then be injected into a respective upstream transmitter subassembly (Tx) 134 via a respective optical band splitting filter 136.

Each upstream transmitter subassembly (Tx) 134 may output an upstream optical signal having the same wavelength as the spectrally sliced channel optical signal that was injected via a respective optical band splitting filter 136. Each upstream optical signal output from each upstream transmitter subassembly (Tx) 134 may be modulated in accordance with upstream data to be transmitted.

Each upstream optical signal output from each upstream transmitter subassembly (Tx) 134 may be coupled to the remote node (RN) 106 via its respective optical band splitting filter 136. The plurality of upstream optical signals transmitted to the remote node (RN) 106 may be input into the multiplexer/demultiplexer 130 to be multiplexed. A resulting multiplexed upstream optical signal may be transmitted to the optical line terminal (OLT) 104 via the optical fiber 110, Also, the multiplexed upstream optical signal transmitted to the optical line terminal (OLT) 104 may be input into the upstream multiplexer/demultiplexer 118b via the optical band splitting filter 124 and the second optical circulator 122b to be demultiplexed. Each resulting demultiplexed upstream optical signal may be directly transmitted to a respective upstream optical receiver (Rx) 128.

As illustrated in FIG. 1, the downstream multiplexer/demultiplexer 118a and the upstream multiplexer/demultiplexer 118b may provide disparate optical transmission paths for a plurality of downstream optical signals and a plurality of upstream optical signals, respectively. The disparate transmission paths for the downstream optical signals and the upstream optical signals may allow the downstream transmitter subassemblies 114 and the upstream receiver subassemblies 116 to be packaged on disparate printed circuit boards (PCBs). By packaging the downstream transmitter subassemblies 114 and the upstream receiver subassemblies 116 on disparate printed circuit boards (PCBs), an optimal combination of standardized optical components may be used for the downstream transmitter subassemblies 114 and the upstream receiver subassemblies 116 in order to increase transmission efficiency while reducing cost. Also, the disparate transmission paths for the downstream optical signals and the upstream optical signals may reduce interference between the downstream optical signals and the upstream optical signals. Further, by directly coupling (e.g., eliminating one or more intervening optical components) the downstream transmitter subassemblies 114 and the downstream multiplexer/demultiplexer 158a or the upstream receiver subassemblies 116 and the upstream multiplexer/demultiplexer 118b, a reflection loss of the plurality of downstream optical signals and the plurality of upstream optical signals may be reduced.

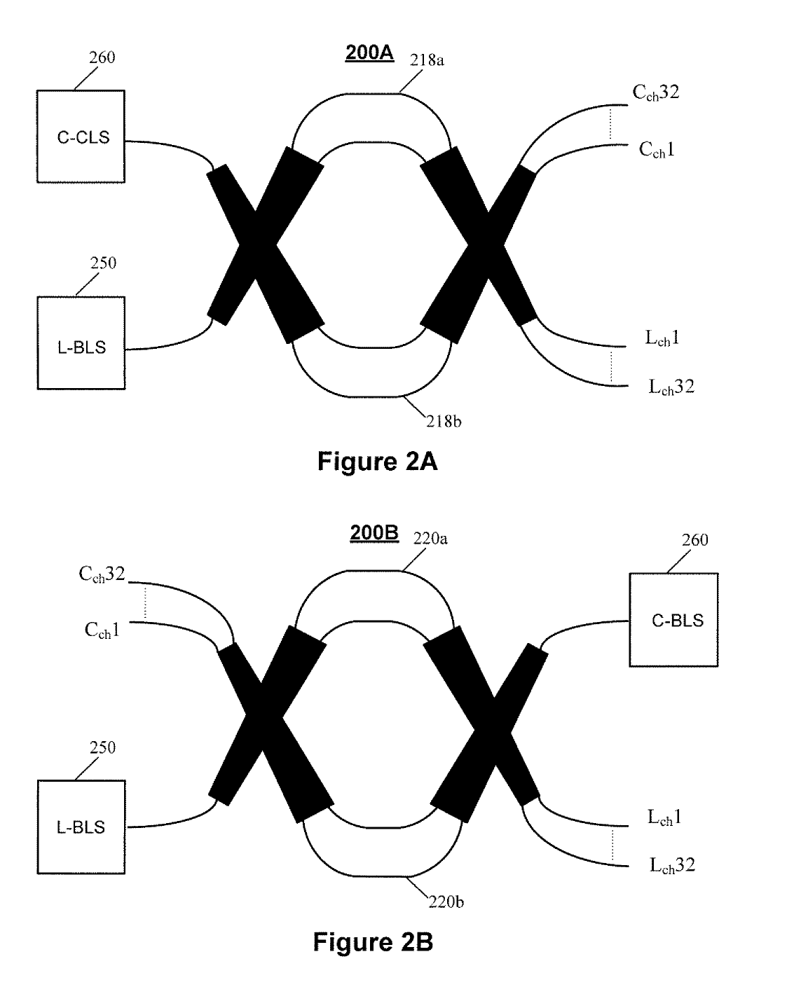

Referring to FIG. 2A, there is shown an embodiment of a dual array waveguide filter 200A for a wavelength division multiplexed passive optical network (WDM-PON) in accordance with an embodiment of the present disclosure. The dual array waveguide filter 200A may comprise a first multiplexer/demultiplexer 218a (e.g., athermal 1×N array waveguide grating (AWG)) and a second multiplexer/demultiplexer 218b (e.g., athermal 1×N array waveguide grating (AWG)) providing disparate optical transmission paths. In an exemplary embodiment, the first multiplexer/demultiplexer 218a may be coupled to a L-band broadband light source 250 generating an L-band broadband optical signal having a wavelength range of 1570 nm to 1620 nm. The second multiplexer/demultiplexer 218b may be coupled to a C-band broadband light source 260 generating a C-band broadband optical signal having a wavelength range of 1520 nm to 1570 nm. As illustrated in FIG. 2A, the L-band broadband light source 250 and the C-band broadband light source 260 may be located on the same side of the dual array waveguide filter 200A. The L-band broadband light source 250 and the C-band broadband light source 260 may simultaneously transmit L-band optical signals and C-band optical signals via the first multiplexer/demultiplexer 218a and the second multiplexer/demultiplexer 218b, respectively, in the same transmission direction.

In an exemplary embodiment, the first multiplexer/demultiplexer 218a and the second multiplexer/demultiplexer 218b may each spectrally slice the L-band broadband optical signals and the C-band broadband optical signals, respectively, into 32 spectral channels (e.g., L_{ch}1-L_{ch}32 and C_{ch}1-C_{ch}32). It may be appreciated by one having ordinary skill in the art that the first multiplexer/demultiplexer 218a and the second multiplexer/demultiplexer 218b may be configured to have a predetermined number of channels in accordance with design specifications of the wavelength division multiplexed passive optical network (WDM-PON).

Referring to FIG. 2B, there is shown another embodiment of a dual array waveguide filter 200B for a wavelength division multiplexed passive optical network (WDM-PON) in accordance with an embodiment of the present disclosure. The dual array waveguide filter 200B is similar to the dual array waveguide filter 200A shown in FIG. 2A, except that the L-band broadband light source 250 and the C-band broadband light source 260 are located on opposite sides of the dual array waveguide filter 200B. For example, by arranging the L-band broadband light source 250 and the C-band broadband light source 260 on opposite sides of the dual array waveguide filter 200B, a reflection loss of the L-band broadband light and the C-band broadband light may be reduced.

In an exemplary embodiment, the L-band broadband light source 250 and the C-band broadband light source 260 may simultaneously input an L-band broadband optical signal and a C-band broadband optical signal into a first multiplexer/demultiplexer 220a and a second multiplexer/demultiplexer 220b in opposite transmission directions. In the event that the L-band broadband optical signal and the C-band broadband optical signal are transmitted in the same direction along the dual array waveguide filter 200B, the L-band broadband optical signal and the C-band broadband optical signal may interfere with each other and cause a reflection loss. Therefore, by transmitting the L-band broadband optical signal and the C-band broadband optical signal in opposite transmission directions, the reflection loss caused by the L-band broadband optical signal and the C-band broadband optical signal interference may be reduced or eliminated.

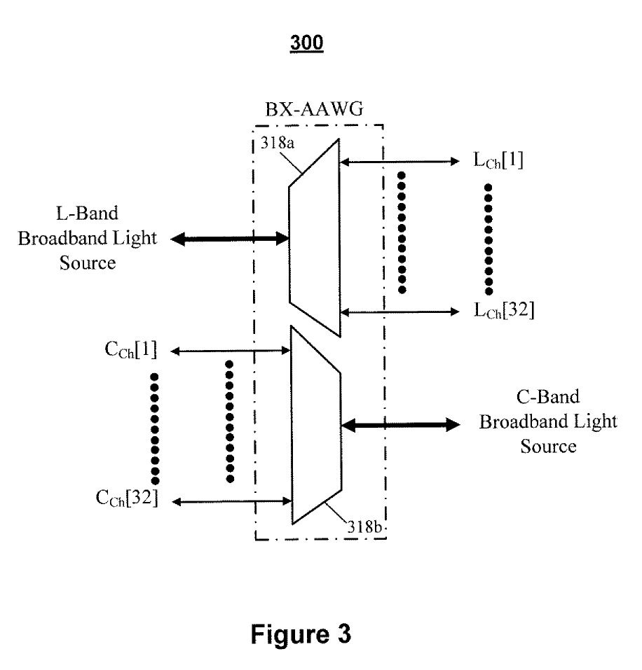

Referring to FIG. 3, there is shown another embodiment of a dual array waveguide filter 300 for a wavelength division multiplexed passive optical network (WDM-PON) in accordance with an embodiment of the present disclosure. The dual array waveguide filter 300 may include a first multiplexer/demultiplexer 318a and a second multiplexer/demultiplexer 318b. In an exemplary embodiment, the first multiplexer/demultiplexer 318a and the second multiplexer/demultiplexer 318b may be athermal or insensitive to temperature change. The first multiplexer/demultiplexer 318a may be coupled to an L-band broadband light source and the second multiplexer/demultiplexer 318b may be coupled to a C-band broadband light source.

The first multiplexer/demultiplexer 318a and the second multiplexer/demultiplexer 318b may be fabricated on a single substrate or disparate substrates. In an exemplary embodiment, the first multiplexer/demultiplexer 318a and the second multiplexer/demultiplexer 318b may be fabricated side by side on a single substrate. In other embodiments, the first multiplexer/demultiplexer 318a and the second multiplexer/demultiplexer 318b may be fabricated overlaying each other on a single substrate.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A passive optical network comprising:
a first light source configured to output a first broadband optical signal for generating a downstream optical signal;
a second light source configured to output a second broadband optical signal for generating an upstream optical signal; and
a dual array waveguide filter having a first optical transmission path and a second optical transmission path, wherein the first optical transmission path is configured to spectrally slice the first broadband optical signal and the second optical transmission path is configured to demultiplex the upstream optical signal.

2. The passive optical network according to claim 1, wherein the first light source is a L-band broadband light source.

3. The passive optical network according to claim 2, wherein the L-band broadband light source outputs the first broadband optical signal having a wavelength range of 1570 nm to 1620 nm.

4. The passive optical network according to claim 1, wherein the second light source is a C-band broadband light source.

5. The passive optical network according to claim a, wherein the C-band broadband light source outputs the second broadband optical signal having a wavelength range of 1520 nm to 1570 nm.

6. The passive optical network according to claim 5, further comprising a first optical circulator configured to couple the first broadband optical signal to the first optical transmission path of the dual array waveguide filter.

7. The passive optical network according to claim 6, further comprising a second optical circulator configured to couple the upstream optical signal to the second transmission path of the dual array waveguide filter.

8. The passive optical network according to claim 1, further comprising one or more downstream transmitter subassemblies each configured to receive at least a portion of the spectrally sliced first broadband optical signal directly from the dual array waveguide filter to generate at least a portion of the downstream optical signal and output the at least a portion of downstream optical signal directly to the first transmission path of the dual array waveguide filter.

9. The passive optical network according to claim 8, further comprising one or more upstream receivers each configured to receive at least a portion of the demultiplexed upstream optical signal from the second transmission path of the dual array waveguide filter.

10. The passive optical network according to claim 9, wherein the one or more downstream transmitter subassemblies and the one or more upstream receivers are packaged on disparate printed circuit boards.

11. The passive optical network according to claim 11, wherein the first transmission path of the dual array waveguide filter comprises a first multiplexer/demultiplexer.

12. The passive optical network according to claim 1, wherein the second transmission path of the dual array waveguide filter comprises a second multiplexer/demultiplexer.

13. The passive optical network according to claim 1, further comprising an optical band splitting filter configured to direct the downstream optical signal to a plurality of optical network terminals via a remote node and direct the upstream optical signal from the plurality of optical network terminals via the remote node.

14. The passive optical network according to claim 13, wherein the remote node comprises an athermal array waveguide grating configured to spectrally slice the second broadband optical signal.

15. The passive optical network according to claim 14, wherein each of the plurality of optical network terminals comprises an upstream transmitter subassembly configured to receive at least a portion of the spectrally sliced second broadband optical signal to generate at least a portion of the upstream optical signal.

16. The passive optical network according to claim 13, wherein each of the plurality of optical network terminals comprises a downstream optical receiver configured to receive at least a portion of the downstream optical signal.

17. The passive optical network according to claim 13, wherein each of the plurality of optical network terminals comprises an optical band splitting filter configured to direct the downstream optical signal and the upstream optical signal.

18. A passive optical network comprising:
a L-band light source configured to output a L-band broadband optical signal for generating a downstream optical signal;
a C-band light source configured to output a C-band broadband optical signal to a plurality of optical network terminals via a remote node for generating an upstream optical signal; and
a dual array waveguide filter having a first optical multiplexer/demultiplexer and a second optical multiplexer/demultiplexer, wherein the first optical multiplexer/demultiplexer is configured to spectrally slice the L-band broadband optical signal and the second optical multiplexer/demultiplexer is configured to demultiplex the upstream optical signal.

19. The passive optical network according to claim 18, wherein the remote node comprises an athermal multiplexer/demultiplexer configured to spectrally slice the C-band broadband optical signal.

20. The passive optical network according to claim 19, wherein each of the plurality of optical network terminals comprises an upstream transmitter subassembly configured to receive the spectrally sliced C-band broadband optical signal via an optical band splitting filter and generate at least a portion of the upstream optical signal.
